(19) United States
(12) Patent Application Publication
(10) Pub. No.: US 2026/0264688 A1
(43) Pub. Date: Sep. 10, 2026

(54) METHOD AND CONTROL DEVICE FOR CONTROLLING A DIFFERENTIAL GEAR OF A VEHICLE

(71) Applicant: ZF Friedrichshafen AG, Friedrichshafen (DE)

(72) Inventors: Raphael GONZALEZ, Leutkirch (DE); Dieter BALZ, Wangen im Allgäu (DE); Andreas RIEGGER, Ravensburg (DE); Joachim SAUTER, Berg (DE); Nikolai EGLER, Riedhausen (DE); Markus RIESTER, Wald (DE)

(73) Assignee: ZF Friedrichshafen AG, Friedrichshafen (DE)

(21) Appl. No.: 19/557,867

(22) Filed: Mar. 5, 2026

(30) Foreign Application Priority Data
Mar. 5, 2025 (DE) 10 2025 108 342.8

(51) Int. Cl. B60W 30/18; B60W 10/16; B60W 10/20; B62D 12/00

(52) U.S. Cl. CPC B60W 30/18172; B60W 10/16; B60W 10/20; B62D 12/00; B60W 2520/28; B60W 2720/28

(57) ABSTRACT

A method for controlling a differential gear of a vehicle having articulated steering includes reading in (S1a) temporally successive steering angles of the articulated steering, determining (S2) a steering angle change based on the read-in steering angles, and setting (S3) a wheel speed correction value for a wheel of the vehicle based on the determined steering angle change. The method further comprises determining (S5) a corrected wheel speed of the wheel by applying (S4) the set wheel speed correction value to a wheel speed of the wheel, and outputting (S6) a control command to the differential gear to change an operating state of the differential gear based on the determined corrected wheel speed. A control device for controlling a differential gear of a vehicle having articulated steering can be configured to perform the method. A vehicle can include such a control device.

### RELATED APPLICATIONS

This application claims the benefit of and right of priority under 35 U.S.C. § 119 to German Patent Application no. 10 2025 108 342.8, filed on 5 Mar. 2025, the contents of which are incorporated herein by reference in its entirety.

### TECHNICAL FIELD

The present invention relates to a method for controlling a differential gear of a vehicle having an articulated steering system. The present invention also relates to a control device for controlling such a differential gear and to a vehicle equipped with such a control device.

### BACKGROUND

The prior art includes vehicles that have articulated steering and a differential gear. The differential gear of such vehicles can be locked to ensure wheel-synchronous load distribution, thereby preventing wheel slip and increasing traction. It is also known that incorrect switching of the differential gear to a locked or open state can cause such vehicles to enter an unsafe operating condition.

### SUMMARY OF THE INVENTION

A first aspect relates to a method for controlling a differential gear of a vehicle that has articulated steering. The vehicle may be a commercial vehicle, such as an articulated bus, or a self-propelled work machine, such as a construction machine. According to one embodiment, the vehicle is an articulated dump truck or wheel loader. The vehicle may be a two-axle or multi-axle vehicle.

The differential gear may have or be a transverse differential. The transverse differential may be an axle differential. The transverse differential can be located in one axle of the vehicle. Alternatively, or in addition to the transverse differential, the differential gear may have or be a longitudinal differential.

The longitudinal differential can be arranged in a transmission that connects two axles of the vehicle via a shaft, for example a cardan shaft. The longitudinal differential can be arranged on the shaft. The longitudinal differential may have a planetary gear.

The method includes the step of reading temporally successive steering angles of the articulated steering. The steering angles can correspond to or be based on the articulation angle of the articulated steering. The articulated steering can connect a front axle and a rear axle of the vehicle via an articulated joint of the articulated steering. Steering the vehicle may cause the front axle and rear axle to pivot or articulate. At least one axle of the front axle and rear axle may be rigidly mounted on the vehicle. At least one axle of the front axle and the rear axle can each have a wheel set, which has at least one left wheel and one right wheel.

The method includes, as a further step, determining a steering angle change based on the read-in steering angles. The steering angle change can be determined based on a time derivative of the read-in steering angle. The determination step can be performed at high frequency. The steering angle change can occur in the vehicle when the vehicle is in a static driving situation while stationary or in a dynamic driving situation while in motion.

The method further comprises setting a wheel speed correction value for a wheel of the vehicle based on the determined steering angle change. The wheel speed correction value may correspond to the steering angle change or may include the steering angle change. The wheel speed correction value may be a wheel speed value which compensates for or eliminates the wheel speeds and differential speeds resulting from the change in steering angle for the purpose of outputting a control command to a differential gear.

The method further comprises determining a corrected wheel speed of the wheel by applying the set wheel speed correction value to a wheel speed of the wheel. The wheel speed can be a predetermined wheel speed. As an alternative to the predetermined wheel speed, the wheel speed can be a detected wheel speed. The method may therefore comprise a further step of detecting the wheel speed using a speed sensor arranged on the wheel. The corrected wheel speed may be a wheel speed that has been corrected by a wheel speed resulting from the change in steering angle. Applying the set wheel speed correction value to the wheel speed of the wheel may therefore involve correcting or compensating for the wheel speed resulting from the change in steering angle at the wheel.

The method further comprises issuing a control command to the differential gear to change an operating state of the differential gear based on the determined corrected wheel speed. The issuance of the control command can be performed automatically, wherein a driver of the vehicle can select automated issuance of the control command. Changing the operating state may involve switching the differential gear from an open state to a locked state. Alternatively, changing the operating state may involve switching the differential gear from a locked state to an open state. When the differential gear is open, it can provide speed compensation via the vehicle's wheels. If the differential gear is a transverse differential, the differential gear can provide speed compensation or torque distribution across the wheels of one axle of the vehicle when open. If the differential gear is a longitudinal differential, the differential gear can provide speed compensation or torque distribution across the wheels of different axles of the vehicle when open. When locked, the differential gear can provide synchronous load distribution across the corresponding wheels of the vehicle.

The method allows influences on the wheel speeds resulting from the steering movement of an articulated steering system with a changing steering angle to be taken into account when controlling a differential gear, wherein the influences on the wheel speeds can be compensated. The method can therefore provide steering motion compensation for wheel speed-dependent control of a differential gear. The method also allows influences that cannot be modeled using a single-track model to be taken into account in order to improve the control of the differential gear during the steering movement of the articulated steering with a changing steering angle. The method can also be used to detect and take into account further steering movements while stationary with a changing steering angle and the resulting wheel speeds or differential speeds in order to improve the control of the differential gear even during a steering movement of the articulated steering while stationary. Furthermore, the method can reduce material wear on the vehicle's wheels and the use of resources for operating the vehicle through improved use of the differential gear in the vehicle's operation.

According to one embodiment of the method, the step of determining the corrected wheel speed can be performed by applying the set wheel speed correction value to a predetermined wheel speed of the wheel. The predetermined wheel speed may be a modeled wheel speed. The predetermined wheel speed may be modeled from at least one of a driving speed, a steering angle, and at least one geometric parameter of the vehicle. The method can thus be used to correct a predetermined wheel speed in such a way that, by applying the set wheel speed correction value to the predetermined wheel speed of the wheel, a portion resulting from the change in steering angle, which has not been predetermined, is compensated for the wheel speed occurring at the wheel. According to this embodiment, the influences of an articulated steering can also be taken into account for statically predetermined wheel speeds for controlling a differential gear. This allows loss of traction at the wheels to be detected more reliably and eliminated by locking the differential gear.

According to a further embodiment of the method, the predetermined wheel speed may be a modeled wheel speed that has been modeled based on a single-track model for the vehicle. The single-track model may be a static single-track model for the vehicle. The effects of articulated steering on such statically modeled wheel speeds can therefore also be taken into account for controlling a differential gear. Tolerated wheel speeds or differential speeds can thus be detected particularly reliably at the wheels and permitted by not engaging the differential lock.

According to a further embodiment of the method, this may include a further step of reading in a detected wheel speed of the wheel. According to this embodiment, the step of determining the corrected wheel speed can be performed by applying the set wheel speed correction value to the read-in detected wheel speed of the wheel. The method can thus be used to correct a detected wheel speed in such a way that, by applying the set wheel speed correction value to the detected wheel speed of the wheel, the portion resulting from the change in steering angle, which cannot be predetermined or modeled, is compensated for in the wheel speed occurring at the wheel. According to this embodiment, the influences of an articulated steering can also be taken into account for detected wheel speeds for controlling a differential gear. A loss of traction at the wheels can also be detected more reliably and eliminated by locking the differential gear.

According to another embodiment of the method, the step of determining the wheel speed correction value may include applying a predetermined calculation factor to the determined steering angle change. The calculation factor may have or be a proportionality factor for converting the determined steering angle change to the proportion of the wheel speed resulting from the steering angle change at the wheel. According to this embodiment, the wheel speed correction value can be efficiently determined and used as a basis for controlling the differential gear.

According to a further embodiment of the method, in the step of determining the wheel speed correction value, the wheel speed correction value can be determined as a function of a predetermined limit value for the determined steering angle change. The wheel speed correction value can thus be limited to a maximum value for the steering angle change. According to this embodiment, outliers for the set wheel speed correction value can be efficiently filtered, for example.

According to a further embodiment of the method, in the step of determining the corrected wheel speed, applying the set wheel speed correction value may comprise adding the set wheel speed correction value and the predetermined wheel speed. If the predetermined wheel speed has been predetermined without taking into account the wheel speed portion resulting from the change in steering angle, this can be corrected by adding the set wheel speed correction value and the predetermined wheel speed. The wheel speed correction value can be positive or negative depending on the direction of rotation of the wheel. According to this embodiment, the method may include, as a further step, reading in a detected wheel speed of the wheel.

According to this embodiment, the method may include a further step of comparing the read-in detected wheel speed with the determined corrected wheel speed. The step of issuing the control command can be performed depending on a comparison result resulting from the comparison step. If the comparison result shows that the recorded wheel speed is higher than the corrected wheel speed, a control command can be issued to set the differential gear to a locked state. This means that the differential gear can be locked, taking into account the wheel speed portion resulting from the change in steering angle. A wheel speed portion resulting from slippage on the wheel can thus be reliably detected, reducing incorrect shifting of the differential gear.

According to a further embodiment of the method, in the step of determining the corrected wheel speed, applying the set wheel speed correction value may comprise subtracting the set wheel speed correction value from the read-in detected wheel speed. If the recorded wheel speed has been influenced by the wheel speed portion resulting from the change in steering angle, this can be corrected by subtracting the set wheel speed correction value from the recorded wheel speed. The wheel speed correction value can be positive or negative depending on the direction of rotation of the wheel.

According to this embodiment, the method may further comprise comparing a predetermined wheel speed with the determined corrected wheel speed. The step of issuing the control command can be performed depending on a comparison result resulting from the comparison step. If the comparison result shows that the predetermined wheel speed is lower than the corrected wheel speed or that the corrected wheel speed is higher than the predetermined wheel speed, a control command can be issued to set the differential gear to a locked state. In this way, the differential gear can also be locked, taking into account the wheel speed portion resulting from the change in steering angle. A wheel speed portion resulting from wheel slip can also be reliably detected, reducing incorrect shifting of the differential gear.

According to a further embodiment of the method, the steps of setting the wheel speed correction value and determining the corrected wheel speed can be performed repeatedly for two wheels of the vehicle. The steps of setting the wheel speed correction value and determining the corrected wheel speed can be repeated for all wheels of the vehicle. The two wheels may be a wheel set on one axle of the vehicle. The two wheels can be a left wheel and a right wheel of the axle. All wheels can be a left wheel and a right wheel of a front axle and a left wheel and a right wheel of a rear axle. The steps of setting the wheel speed correction value and determining the corrected wheel speed can be performed for both the left wheel and the right wheel of the vehicle.

According to this embodiment, the method may comprise, as a further step, determining a corrected difference speed of the two wheels by applying the set wheel speed correction values to the wheel speeds of the two wheels. The corrected differential speed can be determined from the difference between a corrected wheel speed for the left wheel and a corrected wheel speed for the right wheel. The corrected wheel speed for the left wheel and the corrected wheel speed for the right wheel can each be determined in the step of determining the corrected wheel speed. In principle, all steps of the method can be carried out using a corresponding differential speed instead of a wheel speed.

The output step can be performed based on the corrected differential speed. According to this embodiment, the method may include a further step of comparing a differential speed, which can be calculated from read-in detected wheel speeds or which may be predetermined, with the corrected differential speed. The step of issuing the control command can be performed depending on a comparison result resulting from the comparison step. If the comparison result shows that the differential speed deviates from the corrected wheel speed, a control command can be issued to lock the differential gear.

Another aspect relates to a control device for controlling a differential gear of a vehicle having articulated steering, wherein the control device is arranged to perform the method according to the preceding aspect.

Another aspect relates to a vehicle that has an articulated steering system and a control unit as described in the previous aspect for controlling a differential gear of the vehicle.

### BRIEF DESCRIPTION OF THE FIGURES

FIG. 1 schematically shows a vehicle with articulated steering and a control unit for controlling a differential gear of the vehicle according to respective embodiments.

FIG. 2 shows a schematic flowchart with steps of a method for controlling the differential gear using a corrected wheel speed or a corrected differential speed according to one embodiment.

FIG. 3 shows a time curve of the corrected wheel speed for a steering angle curve of the vehicle at a standstill according to one embodiment.

FIG. 4 shows a further time curve of the corrected wheel speed for a steering angle curve of the vehicle in motion according to a further embodiment.

### DETAILED DESCRIPTION OF EMBODIMENTS

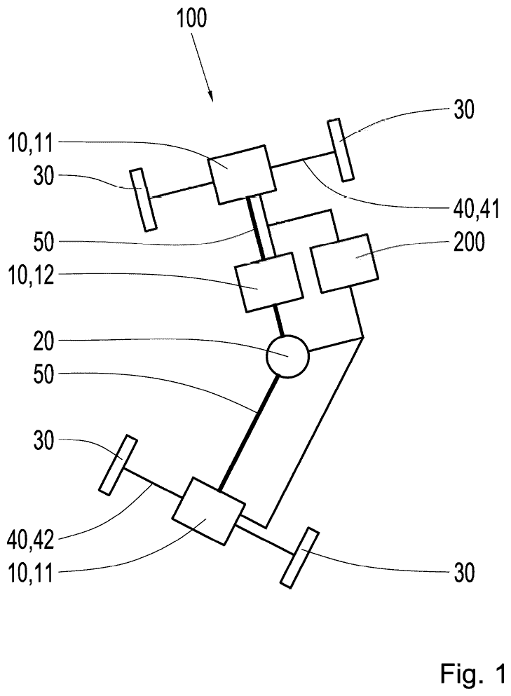

FIG. 1 schematically shows a vehicle 100 that has an articulated steering system 20. Vehicle 100 has two axles 40, which are connected via the articulated steering 20. The articulated steering 20 causes the two axles 40 to pivot horizontally relative to each other. Horizontal pivoting takes place around a vertical axis in a horizontal plane. The horizontal pivoting of the two axles 40 results in wheel movements on wheels 30 of vehicle 100, which superimpose on the wheel movements of wheels 30 resulting from driving. The horizontal pivoting also results in wheel movements of the wheels 30, even when the vehicle 100 is stationary.

The vehicle 100 has a differential gear 10, which comprises at least one of a transverse differential 11 and a longitudinal differential 12. The transverse differential 11 is arranged on at least one axle 40 and connects a left wheel 30 and a right wheel 30 of the axle 40. The vehicle 100 shown in FIG. 1 has a transverse differential 11 on each of the front axle 41 and rear axle 42, wherein one transverse differential 11 connects a left wheel 30 and a right wheel 30 of the front axle 41, and another transverse differential 11 connects a left wheel 30 and a right wheel 30 of the rear axle 42. The longitudinal differential 12 is arranged on a drive shaft 50, which connects the two axles 40 and their wheels 30.

The vehicle 100 also has a control unit 200 which is set up to control the differential gear 10. The control unit 200 is configured to control at least one of the transverse differential 11 and the longitudinal differential 12. The control unit 200 is connected to the articulated steering 20 and configured to read a steering angle caused by the articulated steering 20. The control unit 200 is further connected to the differential gear 10 in order to control it in such a way that the differential gear 10 is set to a locked or open state.

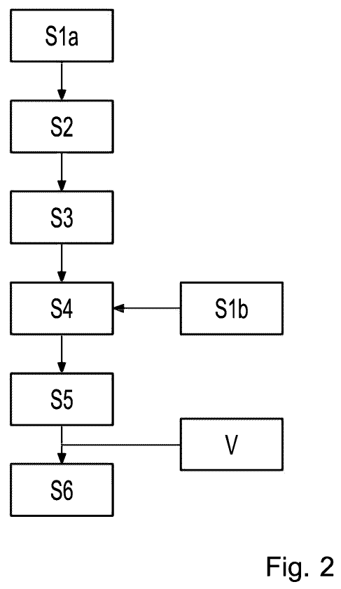

FIG. 2 shows a flowchart with steps of a method for controlling the differential gear 10 of the vehicle 100 in a chronological sequence of the steps according to one embodiment. The control unit 200 of the vehicle 100 is set up to carry out the steps of the method and to control the differential gear 10.

In a first step S1a of the method, the control unit 200 reads the chronologically successive steering angles of the articulated steering 20 of the vehicle 100. Step S1a, as well as the subsequent steps of the method, can be performed when the vehicle 100 is stationary or in motion, wherein the articulated steering 20 causes the wheels 30 to move by changing the steering angle both when stationary and in motion. In a further step S2 of the method, a steering angle change is determined based on the read-in steering angles, wherein the steering angle change is calculated by deriving the steering angles over time. If there is a change in the steering angle of the articulated steering 20, this results in wheel movements and wheel speeds of the wheels 30 resulting from the change in the steering angle. The resulting wheel movements and wheel speeds are corresponding counter-rotating movements and speeds on opposite sides of the axles 40.

In a further step S3 of the method, a wheel speed correction value for a wheel 30 is set based on the determined steering angle change. Step S3 is performed for each wheel 30 of an axle 40. The wheel speed correction value is calculated from the determined steering angle change and a calculation factor applied to it. The wheel speed correction value corresponds to the wheel speed of wheel 30 resulting from the change in steering angle. In a further step S4, the wheel speed correction value is applied to a wheel speed of wheel 30 by means of addition or subtraction. The wheel speed of wheel 30 is a predetermined wheel speed for wheel 30 or a wheel speed detected on wheel 30. The measured wheel speed is read in a further step S1b, wherein the detected wheel speed is captured by a speed sensor on the wheel 30, which is not shown in the figures and is connected to the control unit 200. In yet another step S5, a corrected wheel speed of wheel 30 is determined.

If the wheel speed is the predetermined wheel speed, which, according to one embodiment, has been modeled from a static single-track model for the vehicle 100, the corrected wheel speed of the wheel 30 is calculated in step S5 by adding the set wheel speed correction value and the predetermined wheel speed. The corrected wheel speed is then a corrected predetermined or modeled wheel speed. In this process, a wheel speed portion resulting from the change in steering angle, which is not present in the predetermined wheel speed, is compensated for by addition. The corrected predetermined wheel speed then has the wheel speed portion resulting from the change in steering angle. The corrected wheel speed thus essentially corresponds to the wheel speed portion resulting from the change in steering angle when the axles 40 of the vehicle 100 bend due to a steering movement of the articulated steering 20 with a changing articulation angle. The corrected wheel speed thus continues to correspond essentially to the sum of the wheel speed portion resulting from the driving speed and the steering angle and the wheel speed portion resulting from the change in steering angle when the vehicle 100 is moving at a constant steering angle.

If the wheel speed is the detected wheel speed, the corrected wheel speed of wheel 30 in step S5 is calculated by subtracting the set wheel speed correction value from the detected wheel speed. The corrected wheel speed is then a corrected recorded wheel speed. In this process, a portion of the wheel speed resulting from the change in steering angle, which is present in the recorded wheel speed, is compensated for by subtraction. The corrected recorded wheel speed then no longer includes the wheel speed portion resulting from the change in steering angle. The corrected wheel speed is therefore essentially zero when the axles 40 of the vehicle 100 bend by a steering movement of the articulated steering 20 with a changing articulation angle. The corrected wheel speed thus continues to correspond essentially to the wheel speed portion resulting from the driving speed and the steering angle when the vehicle 100 is moving at a constant steering angle.

If it is the corrected predetermined or modeled wheel speed, in a further step V of the method, a detected wheel speed is compared with the corrected wheel speed. If step V results in a comparison showing that the detected wheel speed deviates from the corrected predetermined or modeled wheel speed, a control command is issued to the differential gear 10 in a further step S6. The control command is issued to cause the differential gear 10 to be placed in a locked state in order to reduce detected slip at the wheel 30 and increase traction at the wheel 30. If steps S3, S4, and S5 are performed for a left wheel 30 and a right wheel 30 of an axle 40, steps V and S6 are performed according to an embodiment for corresponding differential speeds.

If the corrected wheel speed is recorded, a predetermined or modeled wheel speed is compared with the corrected wheel speed in the next step V of the method. If step V results in a comparison result showing that the corrected recorded wheel speed deviates from the predetermined or modeled wheel speed, the control command is issued to the differential gear 10 in the further step S6. The control command is issued to cause the differential gear 10 to be locked in order to reduce detected slip at the wheel 30 and increase traction at the wheel 30. If steps S3, S4, and S5 are performed for a left wheel 30 and a right wheel 30 of an axle 40, steps V and S6 are performed according to an embodiment for corresponding differential speeds.

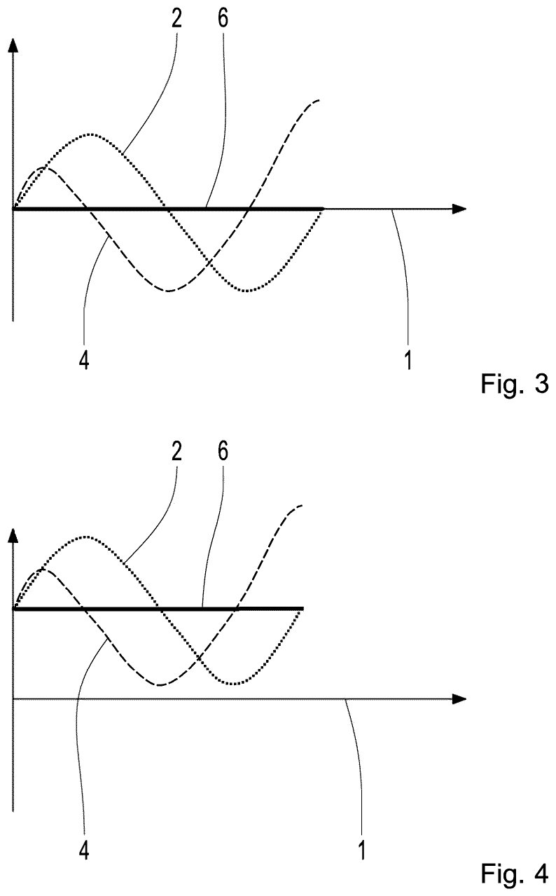

FIG. 3 shows a time curve 1 of the steering angle 2, in which the vehicle 100 is stationary and the articulated steering 20 generates the changing steering angle 2. According to the exemplary embodiment shown in FIG. 3, the changing steering angle 2 initially runs positively for an inward bend of the articulated steering 20 to the right and negatively for a subsequent inward bend of the articulated steering 20 to the left. Furthermore, according to the exemplary embodiment shown in FIG. 3, the detected wheel speed 4 for the left wheel 30 of the front axle 41 of the vehicle 100 runs in a positive direction when the steering angle 2 increases to the right or when the vehicle is turned to the right, and in a negative direction when the steering angle 2 increases to the left or when the vehicle is turned to the left. FIG. 3 also shows a time curve 1 of the corrected wheel speed 6, which no longer includes the wheel speeds 4 resulting from the steering angle changes when stationary and has a value of zero. The corrected wheel speed 6 corresponds to a wheel speed portion that is not present when the vehicle 100 is stationary, which results from the vehicle 100 traveling at a constant steering angle and corresponds to a correspondingly statically modeled wheel speed.

FIG. 4 shows another time curve 1 of the steering angle 2, in which, in contrast to the exemplary embodiment shown in FIG. 3, the vehicle 100 is in motion and the articulated steering 20 generates the changing steering angle 2. In the exemplary embodiment shown in FIG. 4, the changing steering angle 2 proceeds as described in

FIG. 3, wherein the steering angle 2 has a constant steering angle portion resulting from cornering. Furthermore, according to the exemplary embodiment shown in FIG. 4, the detected wheel speed 4 also proceeds as described in FIG. 3, wherein the detected wheel speed 4 has a constant wheel speed portion resulting from the driving speed of the vehicle 100 and the cornering. FIG. 4 also shows a time curve 1 of the corrected wheel speed 6, which no longer includes the portions of the wheel speeds resulting from the steering angle changes and has a constant value. The corrected wheel speed 6 corresponds to the constant wheel speed portion resulting from the driving speed of the vehicle 100 and the cornering, which corresponds to a correspondingly statically modeled wheel speed.

### Reference Numbers

1 time curve
2 steering angle
4 wheel speed
6 corrected wheel speed
10 differential gear
11 transverse differential
12 longitudinal differential
20 articulated steering
30 wheel
40 axle
41 front axle
42 rear axle
50 drive shaft
100 vehicle
200 control unit
S1a reading steering angle
S1b reading measured wheel speed
S2 determine steering angle change
S3 set wheel speed correction value
S4 application of wheel speed correction value
S5 wheel speed determination
S6 issuing of control command
V wheel speed comparison

1. A method for controlling a differential gear (10) of a vehicle (100) having an articulated steering system (20), comprising:
reading (S1a) temporally successive steering angles (2) of the articulated steering (20);
determining (S2) a steering angle change based on the temporally successive steering angles (2);
setting (S3) a wheel speed correction value for a wheel (30) of the vehicle (100) based on the steering angle change;
determining (S5) a corrected wheel speed (6) of the wheel (30) by applying (S4) the wheel speed correction value to a wheel speed (4) of the wheel (30); and
outputting (S6) a control command to the differential gear (10) for changing an operating state of the differential gear (10) based on the corrected wheel speed (6).

2. The method according to claim 1, wherein determining (S5) the corrected wheel speed (6) is performed by applying (S4) the wheel speed correction value to a predetermined wheel speed (4) of the wheel (30).

3. The method according to claim 2, wherein the predetermined wheel speed (4) is a modeled wheel speed (4) that has been modeled based on a single-track model for the vehicle (100).

4. The method according to claim 1, comprising:
reading in (S1b) a detected wheel speed (4) of the wheel (30);
wherein determining (S5) the corrected wheel speed (6) is performed by applying (S4) the set wheel speed correction value to the detected wheel speed (4) of the wheel (30).

5. The method according to claim 1, wherein determining (S3) the wheel speed correction value comprises applying a predetermined calculation factor to the determined steering angle change.

6. The method according to claim 1, wherein determining (S3) the wheel speed correction value is based on a predetermined limit value for the determined steering angle change.

7. The method according to claim 6, wherein in the step of determining (S5) the corrected wheel speed (6), applying (S4) the set wheel speed correction value comprises adding the set wheel speed correction value and the predetermined wheel speed (4), and the method further comprises:
reading (S1b) a detected wheel speed (4) of the wheel (30); and
comparing (V) the read detected wheel speed (4) with the determined corrected wheel speed (6);
wherein outputting (S6) the control command is performed depending on a comparison result resulting from the step of comparing (V).

8. The method according to claim 4, wherein in the step of determining (S5) the corrected wheel speed (6) the application (S4) of the set wheel speed correction value comprises subtracting the set wheel speed correction value from the read-in detected wheel speed (4), the method further comprising:
comparing (V) a predetermined wheel speed (4) with the determined corrected wheel speed (6);
wherein the step of outputting (S6) the control command is performed depending on a comparison result resulting from the step of comparing (V).

9. The method according to claim 1, wherein the steps of setting (S3) the wheel speed correction value and determining (S5) the corrected wheel speed (6) are performed repeatedly for two wheels (30) of the vehicle (100), with the further step of determining a corrected differential speed of the two wheels (30) by applying (S4) the set wheel speed correction values to wheel speeds (4) of the two wheels (30), and wherein the step of outputting (S6) is performed based on the corrected differential speed.

10. A control device (200) for controlling a differential gear (10) of a vehicle (100) having an articulated steering system (20), wherein the control device (200) is designed to carry out the method according to claim 1.

11. A vehicle (100) comprising:
an articulated steering system (20);
a differential gear; and
a control device (200) for controlling the differential gear (10), wherein the control device (200) is configured to carry out the method according to claim 1.
